(19) United States
(12) Patent Application Publication
(10) Pub. No.: US 2008/0095529 A1
(43) Pub. Date: Apr. 24, 2008

(54) DIGITAL CAMERA MODULE PACKAGE

(75) Inventors: PO-CHIH HSU, Chu-Nan (TW); MING-YUAN LIN, Chu-Nan (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ALTUS TECHNOLOGY INC., Chu-Nan (TW)

(21) Appl. No.: 11/617,070

(22) Filed: Dec. 28, 2006

(30) Foreign Application Priority Data
Oct. 20, 2006 (CN) 200610063219.1

(51) Int. Cl. G03B 17/00

(52) U.S. Cl. 396/529

(57) ABSTRACT

A digital camera module package (200) includes a base (20), an image sensor chip package (21) and a lens module (22). The image sensor chip package is mounted on the base. The lens module includes a cavity (257). The cavity fittingly receives the image sensor chip package, and presses against a circumferential wall of the image sensor chip package. The digital cameral module package may precisely align the image sensor chip package with the lens module.

### BACKGROUND OF THE INVENTION

1. Field of the Invention

The present invention generally relates to an IC (integrated circuit) chip package and, more particularly, to a digital camera module package which may precisely align an image sensor chip package with a lens module.

2. Discussion of the Related Art

Image sensors are widely used in digital camera modules in order to convert the optical image data of an object into electrical signals. In order to attain a better image quality, the image sensor should be precisely aligned with a lens module.

A typical digital camera module 100 is illustrated in FIG. 5. The digital camera module 100 is constructed to include a base 10, an image sensor chip package 11 and a lens module 12. The image sensor chip package 11 includes a chip 111 and a cover 113. The chip 111 has a photosensitive area. The cover 1113 is positioned on the chip 111 so as to protect the photosensitive area of the chip 111. The image sensor chip package 11 is mounted on the base 10 by means of SMT (surface-mount technology) method, and is electrically coupled to the base 10. The lens module 12 includes a seat 14 and a barrel 15. The barrel 15 is threaded to the seat 14. The seat 14 is fixed on the base 10 by means of an adhesive glue 13.

The image sensor chip package 11 has an axis A1, and the lens module 12 also has an axis A2. In assembly, a concentricity difference exists between the axis A1 and the axis A2 since the image sensor chip package 11 is difficult to align with the lens module 12. Thus, the quality of the image sensor chip package 11 can be affected.

Therefore, a new digital camera module package is desired in order to overcome the above-described shortcomings.

### SUMMARY OF THE INVENTION

One embodiment of a digital camera module package includes a base, an image sensor chip package and a lens module. The image sensor chip package is mounted on the base. The lens module includes a cavity. The cavity is received the image sensor chip package, and presses against a circumferential wall of the image sensor chip package.

Other advantages and novel features will become more apparent from the following detailed description when taken in conjunction with the accompanying drawings.

### BRIEF DESCRIPTION OF THE DRAWINGS

Many aspects of the present digital camera module package can be better understood with reference to the following drawings. The components in the drawings are not necessarily drawn to scale, the emphasis instead being placed upon clearly illustrating the principles of the digital camera module package. Moreover, in the drawings, like reference numerals designate corresponding parts throughout the several views.

FIG. 1 is a schematic, cross-sectional view of a digital camera module with an image sensor chip package according to a first embodiment;

FIG. 2 is a schematic, cross-sectional view of a digital camera module with an image sensor chip package according to a second embodiment;

FIG. 3 is a schematic, cross-sectional view of a digital camera module with an image sensor chip package according to a third embodiment;

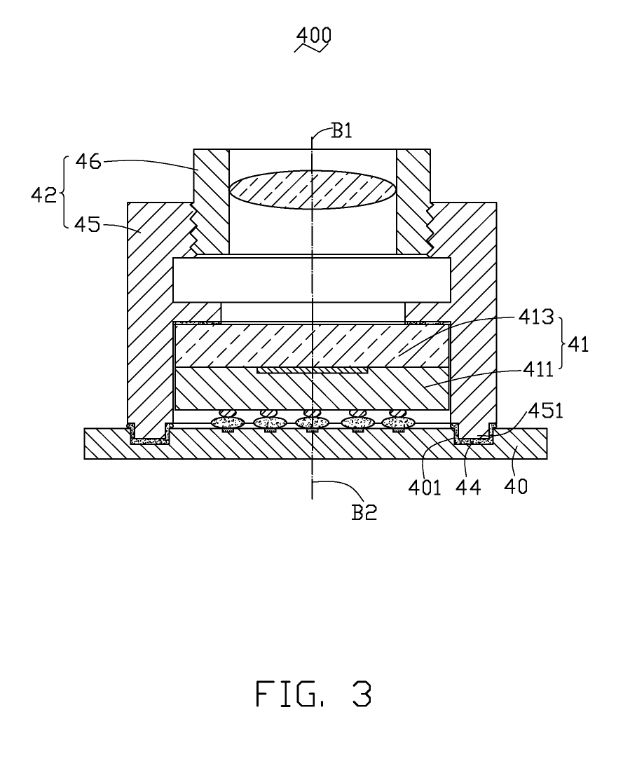

FIG. 4 is a schematic, cross-sectional view of a digital camera module with an image sensor chip package according to a fourth embodiment; and

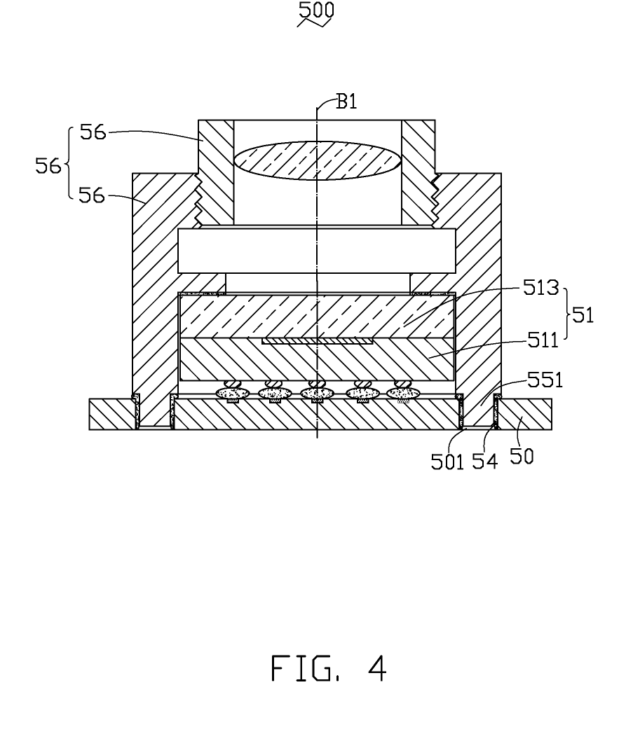

FIG. 5 is a schematic, cross-sectional view of a typical digital camera module package.

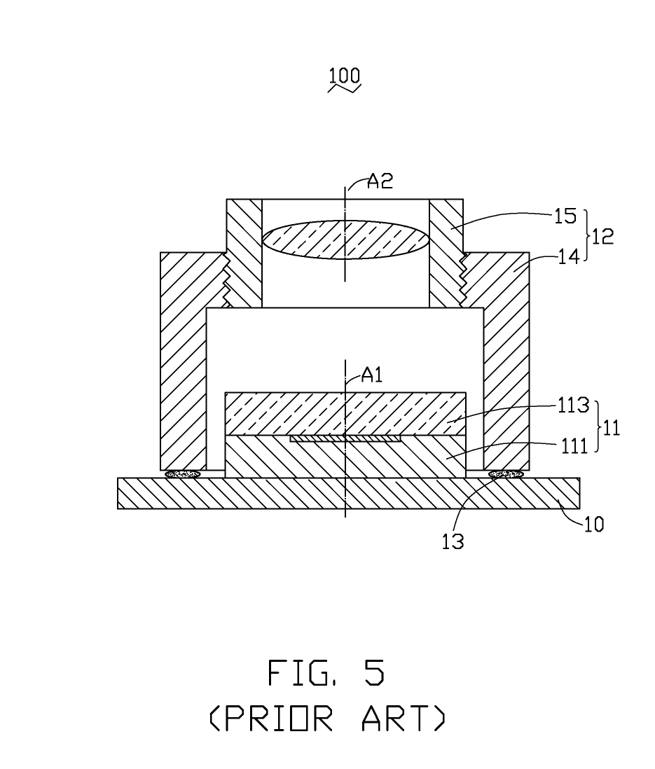

### DETAILED DESCRIPTION OF THE PREFERRED EMBODIMENTS

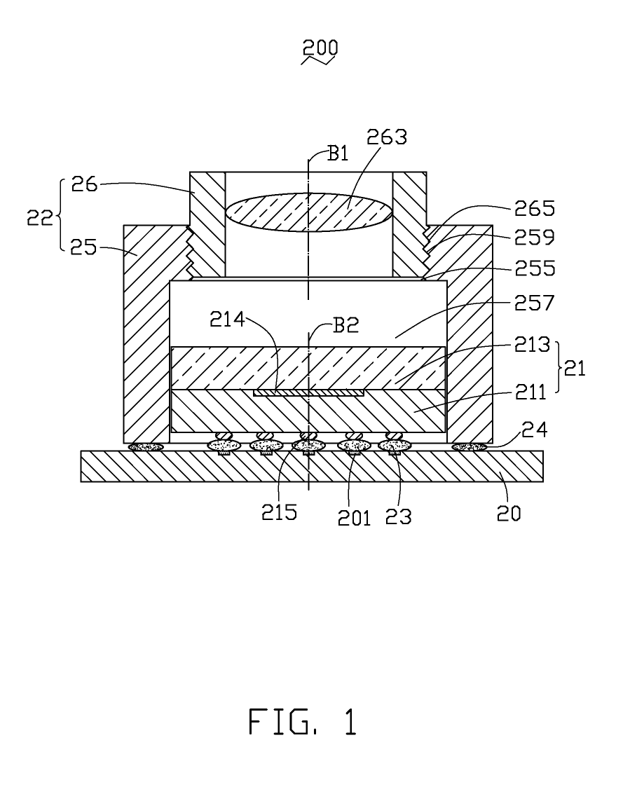

Referring to FIG. 1, a digital camera module package 200 in accordance with a first embodiment is illustrated. The digital camera module 200 includes a base 20, an image sensor chip package 21 and a lens module 22.

The base 20 is substantially boardlike, and includes a plurality of conductive terminals 201. The conductive terminals 201 may be electrically connected to the image sensor chip package 21.

The image sensor chip package 21 includes an image sensor chip 211 and a cover 213. The chip 211 has a top surface and a bottom surface. The top surface includes a photosensitive area 214. The bottom surface has a plurality of pads 215 positioned on it. The cover 213 is transparent and is laid over the image sensor chip 211 which receives light transmitted through the cover 213. The cover 213 is fixed to the image sensor chip 211 by glue (not labeled) so as to protect the photosensitive area 214 of the image sensor chip 211. The image sensor chip package 21 is connected to the base 20 by means of tin cream 23 so that each conductive terminal 201 of the base 20 is electronically connected to a corresponding pad 215.

The lens module 22 includes a seat 25 and a barrel 26. The seat 25 is a hollow cylinder with an open end and a half-closed end. The half-closed end defines a through hole 255 defined by an inner wall. The seat 25 has a cavity 257, which communicates with the through hole 255. The inner wall defines an inner thread 259. The size of the cavity 257 corresponds to that of the image sensor chip package 21. The barrel 26 is substantially a hollow cylinder with two open ends so that light can be transmitted therethrough. Several lens elements 263 (only one is shown) are disposed in the barrel 26, and receive incoming light that enters from the outside. The barrel 26 has an outer thread 265 defined in an outer periphery wall thereof, for engaging with the inner thread 259 of the seat 25.

In assembly, the lens elements 263 are received in the barrel 26. The outer thread 265 of the barrel 26 engages with the inner thread 259 of the seat 25, thus connecting the barrel 26 and the seat 25 with each other. The image sensor chip package 21 is then electrically coupled to the base 20 by means of tin cream 23 so as to cause each conductive terminal 201 of the base 20 to be electronically connected to a corresponding pad 215. After that, the seat 25 is aligned with the image sensor package 21, and is placed around the image sensor chip package 21. Owing to the size of the cavity 257 corresponding to that of the image sensor chip package 21, the image sensor chip package 21 may limit the axis B2 thereof offsetting from the axis B1 of the lens module 22. Finally, the lens module 22 is fixed to the base 20 by an adhesive glue 24. Alternatively, the adhesive glue 24 can be replaced by any other appropriate adhesive means. The assembly process of the digital camera module 200 is thus completed.

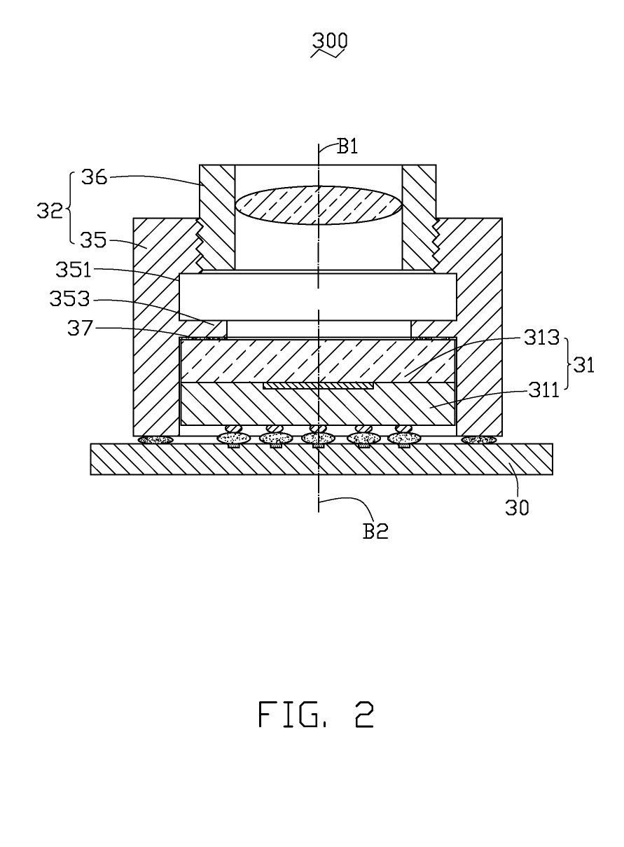

In a second embodiment, referring to FIG. 2, a digital camera module package 300 includes a base 30, an image sensor chip package 31 and a lens module 32. The image sensor chip package 31 includes an image sensor chip 311 and a cover 313. The lens module 32 includes a seat 35 and a barrel 36. The digital cameral module package 300 is mostly the same as the digital camera 200 of the first embodiment, but the seat 35 of the digital camera 300 includes a flange 353 in a cavity 351. When the seat 35 is placed around a circumferential wall of the image sensor chip package 31, the flanges 353 further press against a top surface of the image sensor chip package 31 so as to maintain the concentricity between the lens module 32 and the image sensor chip package 31. An adhesive glue 37 may be applied between the flange 353 and the image sensor chip package 31 in order to improve the strength of the connection.

In a third embodiment, a digital camera module package 400 includes a base 40, an image sensor chip package 41 and a lens module 42. The image sensor chip package 41 includes an image sensor chip 411 and a cover 413. The lens module 42 includes a seat 45 and a barrel 46. The digital camera 400 is mostly the same as the digital camera 300 of the second embodiment, but the seat 45 of the digital camera 400 extends a plurality of feet 451 from one end thereof opposite to the barrel 46. The base 40 defines a plurality of grooves 401 therein. The number of the feet 451 corresponds to that of the grooves 401. Accordingly, each foot 451 may be inserted into a given groove 401 and is fixed to the groove 401 by means of an adhesive glue 44 so as to secure the orientation between the lens module 42 and the image sensor chip package 41.

In a fourth embodiment, a digital camera module package 500 includes a base 50, an image sensor chip package 51 and a lens module 52. The image sensor chip package 51 includes an image sensor chip 511 and a cover 513. The lens module 52 includes a seat 55 and a barrel 56. The digital camera 500 is mostly the same as the digital camera 300 of the second embodiment, but the seat 55 of the digital camera 500 extends a plurality of feet 551 at one end thereof opposite to the barrel 56. The base 50 defines a plurality of through holes 501 therein. The number of the feet 551 corresponds to that of the holes 501. Accordingly, each foot 551 may be inserted into a given hole 501, and is fixed to the hole 501 by means of an adhesive glue 54 so as to secure the orientation between the lens module 52 and the image sensor chip package 51.

In the above embodiments, the seat and the barrel may be integrally formed to a holder. Understandably, the base forms a plurality of pads thereon, and the pads each electronically connect a corresponding one of the chip pads of the image sensor chip. A main advantage of the digital cameral module package is that the lens module may press against a circumferential wall of the image sensor chip package, and may precisely align the image sensor chip package with the lens module. Accordingly, the image quality may be greatly improved.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A digital camera module package comprising:
a base;
an image sensor chip package mounted on the base; and
a lens module including a cavity, the image sensor chip package being fittingly received in the cavity in such a manner that the lens module presses against a circumferential wall of the image sensor chip package.

2. The digital camera module package as claimed in claim 1, wherein an inner wall of the lens module surrounding the cavity extends a flange into the cavity, and the flange presses against a top surface of the image sensor chip package.

3. The digital camera module package as claimed in claim 2, wherein the flange is fixed to the image sensor chip package by adhesive.

4. The digital camera module package as claimed in claim 1, wherein the lens module has at least one foot, the base defines at least one groove, and each foot is received in a corresponding groove.

5. The digital camera module package as claimed in claim 1, wherein the lens module has at least one foot, the base defines at one through hole, and each foot is received in a corresponding hole.

6. The digital camera module package as claimed in claim 1, wherein the lens module includes a seat and a barrel, and the seat is connected to the barrel by thread.

7. The digital camera module package as claimed in claim 1, wherein the image sensor chip package includes a cover and a chip, and the cover is positioned on the chip.

8. A digital camera module comprising:
an image sensor chip package, the image sensor chip package comprising:
a base forming a plurality of pads thereon;
an image sensor chip mounted on the base, the image sensor chip having a photosensitive area formed in a top surface thereof and a plurality of chip pads attached on a bottom surface thereof;
the pads each electronically connecting a corresponding one of the chip pads of the image sensor chip; and
a holder having a barrel mounted on the base, the holder having a cavity, the cavity fitly receiving the image sensor chip package.

9. The digital camera module as claimed in claim 8, wherein an inner wall of the holder surrounding the cavity extends a flange into the cavity, and the flange presses against a top surface of the image sensor chip package.

10. The digital camera module as claimed in claim 9, wherein the flange is fixed to the image sensor chip package by adhesive.

11. The digital camera module as claimed in claim 8, wherein the holder has at least one foot, the base defines at least one groove, and each foot is received in a corresponding groove.

12. The digital camera module as claimed in claim 8, wherein the holder has at least one foot, the base defines at least one through hole, and each foot is received in a corresponding hole.

13. The digital camera module as claimed in claim 8, further comprising a cover, wherein the cover is positioned on the image sensor chip.

14. The digital camera module as claimed in claim 13, wherein the holder includes a seat and a barrel, the cavity is formed in the seat, and the seat is connected to the barrel by thread.

15. The digital camera module as claimed in claim 13, wherein the holder is fixed on the base by adhesive.

16. A digital camera module comprising:
a base forming a plurality of pads thereon;
a holder having a lens mounted at one end thereof and a cavity defined at an opposite end thereof, the holder being mounted on the base with the cavity communicating with the pad; and
an image sensor chip package fittingly received in the cavity, the image sensor chip package comprising an image sensor chip mounted on the base, the image sensor chip having a photosensitive area formed in a top surface thereof and a plurality of chip pads attached on a bottom surface thereof, wherein
each of the pads of the base is electronically connected with a corresponding one of the chip pads of the image sensor chip and an inner wall of the holder surrounding the cavity fittingly abuts an outer wall of the chip so that a central line of the lens aligns with a central line of the photosensitive area of the image sensor chip.

17. The digital camera module as claimed in claim 16, wherein the image sensor chip package further comprises a cover mounted on the top surface of the image sensor chip and the inner wall of the holder surrounding the cavity fittingly abuts the outer wall of the cover.

18. The digital camera module as claimed in claim 17, wherein a flange extends from the inner wall of the holder into the cavity, and the flange presses against the top surface of the image sensor chip.

19. The digital camera module as claimed in claim 18, wherein the holder has at least one foot, the base defines at least one recess, and each foot is received in a corresponding recess.

20. The digital camera module as claimed in claim 18, wherein the holder has at least one foot, the base defines at least one through hole, and each foot is received in a corresponding through hole.
